(19) United States
(12) Patent Application Publication
(10) Pub. No.: US 2005/0254637 A1
(43) Pub. Date: Nov. 17, 2005

(54) Call request control device

(76) Inventors: Megumi Hosoe, Tokyo (JP); Yoshihisa Takebe, Tokyo (JP)

Correspondence Address: INTELLECTUAL PROPERTY / TECHNOLOGY LAW, PO BOX 14329, RESEARCH TRIANGLE PARK, NC, 27709, US

(21) Appl. No.: 10/991,068

(22) Filed: Nov. 17, 2004

(30) Foreign Application Priority Data
May 12, 2004 (JP) 2004-142003

(51) Int. Cl. H04M 3/42; H04M 1/00; H04M 3/00

(52) U.S. Cl. 379/209.01; 379/355.01

(57) ABSTRACT

A call request control device, which in an offhook state, upon detecting a key input, checks the type of the key that was input. When the input key is a transmission/redial key, a determination is made of whether dial data is stored in the dial buffer. If dial data is stored in the dial buffer, then the dial data is set as a call destination number, and a call request message is sent. If dial data is not stored, then redial data is set as the call destination number, and a call request message is sent. Telephone sets incorporating such call request control device have enhanced functionality without corresponding increase in the number of keys.

### BACKGROUND OF THE INVENTION

1. Field of the Invention

The present invention relates to an improved technology for multi-functioning of the keys provided on a telephone set.

2. Description of the Related Art

In a telephone set, such as a conventional IP telephone set or ISDN telephone set that sends the dial data integrally to a network when requesting a call, a dedicated transmission key, for instance, is provided as a means to determine the timing of sending the dial data integrally. By such arrangement, an input operation of this transmission key acts as the trigger for transmission of the data.

If, however, a new dedicated transmission key is installed, the number of the keys to be provided on the telephone set increases. This is not desirable, since the telephone set has a limited number of keys.

### SUMMARY OF THE INVENTION

The present invention relates to the provision of multi-functioned keys on a telephone set to thereby provide a call request control device and an IP telephone set with a reduced number of keys.

In one aspect, the invention relates to a call request control device, including: a dial buffer for storing dial data; a control unit for controlling a call request; and a transmission/redial key for requesting the control unit for a call request process, wherein, in cases where the transmission/redial key is input, if dial data is stored in the dial buffer, the control unit performs call request processing by using the dial data as a call destination number, whereas, if dial data is not stored in the dial buffer, the control unit performs call request processing by using redial data as the call destination number. Since the transmission/redial key functions as a combination of a transmission key and a redial key, it is possible to avoid increasing the number of the keys.

In another aspect, the invention relates to a call request control device, including: a dial buffer for storing dial data; detection means for detecting onhook/offhook status; a control unit for controlling a call request; and a transmission/redial key for requesting the control unit for a call request process, wherein, in cases where the transmission/redial key is input in an offhook state, if dial data is stored in the dial buffer, the control unit performs call request processing by using the dial data as a call destination number, whereas, if dial data is not stored in the dial buffer, the control unit performs call request processing by using redial data as the call destination number. With such configuration, once inputting the transmission/redial key in an offhook state, if dial data is not input, redial transmission is carried out automatically. This arrangement provides a high level of convenience.

In a still further aspect, the invention relates to a call request control device, including: a dial buffer for storing dial data; a display unit for displaying a call destination number; a detection means for detecting onhook/offhook status; a control unit for controlling a call request; and a transmission/redial key for requesting the control unit for a call request process, wherein, in cases where the transmission/redial key is input in an onhook state, if dial data is stored in the dial buffer, the control unit performs call request processing by using the dial data as a call destination number, whereas, if dial data is not stored in the dial buffer, the control unit displays redial data as the call destination number on the display unit, and, when the transmission/redial key is re-input, the control unit performs call request processing by using the redial data as the call destination number. With such configuration, redial transmission is possible by merely inputting the transmission/redial key twice in an onhook state. This arrangement likewise provides a high level of convenience.

In yet another aspect, the invention relates to an IP telephone set including a call request control device of a type as described above. The keys are allowed to have multi-functionality and the number of the keys of the IP telephone set can be reduced by providing the call request control device to the IP telephone set.

### BRIEF DESCRIPTION OF THE DRAWINGS

FIG. 1 is a functional block diagram of an IP telephone set according to one embodiment of the invention;

FIG. 2 is a plan view of a base unit of such IP telephone set;

FIG. 3 is a flow chart explaining call request processing carried out in accordance with such embodiment of the invention; and

FIG. 4 is a flow chart explaining call request processing carried out in accordance with such embodiment of the invention.

### DESCRIPTION OF THE PREFERRED EMBODIMENTS

An illustrative embodiment of the present invention will be described below with reference to the drawings.

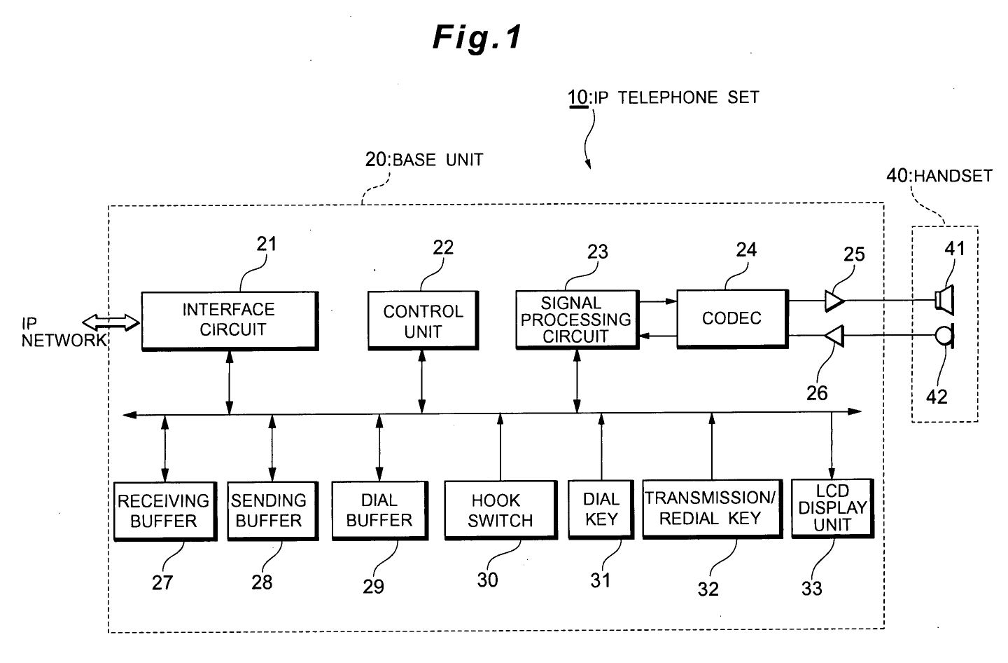

FIG. 1 is a functional block diagram of an IP telephone set 10 including a call request control device of the present embodiment. As shown in the figure, the IP telephone set 10 is constituted by a base unit 20 and a handset 40. The base unit 20 is constituted as including an interface circuit 21, a control unit 22, a signal processing unit 23, a codec 24, a voice amplifier 25, a voice amplifier 26, a receiving buffer 27, a sending buffer 28, a dial buffer 29, a hook switch 30, dial keys 31, a transmission/redial key 32, and a LCD display unit 33.

The voice amplifier 26 is connected to a microphone 42 which is incorporated in the handset 40, and a voice signal which was input to the microphone 42 is amplified in the voice amplifier 26 and is then input to the codec 24. On the other hand, the voice signal which is output from the codec 24 is amplified in the voice amplifier 25, whereby the reinforced sound is output through a speaker 41. The codec 24 includes an A/D converter and D/A converter, in which an analog voice signal which is output from the voice amplifier 26 is converted into a digital voice signal (voice data) and supplied to the signal processing circuit 23, and the voice data which is output from the signal processing circuit 23 is converted into an analog voice signal and output to the voice amplifier 25.

The signal processing circuit 23 is a compressing/expansion circuit for voice data, which is constituted as including a DSP (Digital Signal Processor) or the like, in which: voice data supplied from the codec 24 is compressed and stored in the sending buffer 28; the compressed voice data which is supplied from the control unit 22 is subjected to expansion processing; and the expanded voice is supplied to the codec 24. The interface circuit 21 is a circuit that is constituted as including a MAC (Media Access Control) circuit and PHY (Physical Protocol) circuit, in which: a transmission code sent from a transmission path such as an IP network is subjected to decoding processing and stored in the receiving buffer 27; and the voice data supplied from the control unit 22 is encoded and sent to the transmission path. The control unit 22 is a circuit that executes call control, in which: the voice data stored in the sending buffer 28 is read and then packetized into predetermined frames; the packetized voice data is supplied to the interface circuit 21; the voice data is retrieved from the received data accumulated in the receiving buffer 27 and then supplied to the signal processing circuit 23.

The base unit 20 further comprises the dial buffer 29 for accumulating dial data, hook switch (detection means) 30 for detecting onhook/offhook status of the handset 40, dial keys 31 for dial inputs, transmission/redial key 32 for requesting for a call (including a redial call request), and LCD display unit 33 for displaying the dial data and the like.

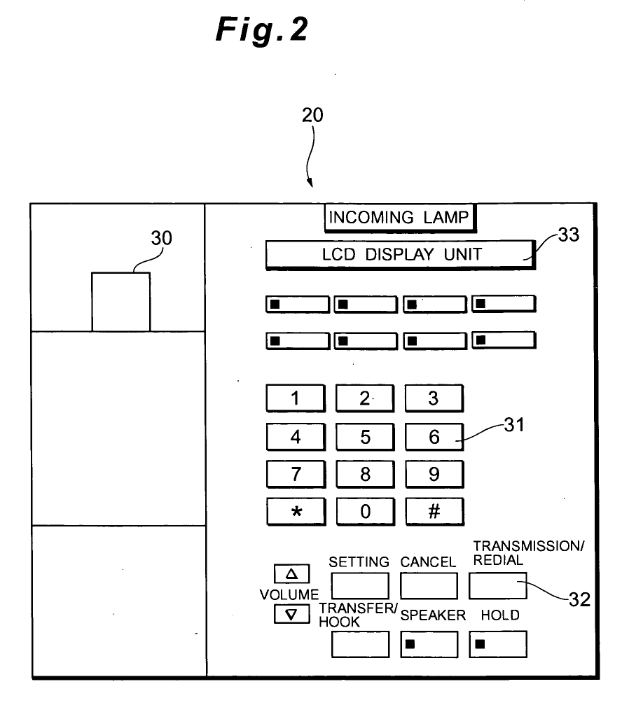

FIG. 2 is a plan view of the base unit 20. As shown in the figure, in addition to the hook switch 30, dial keys 31, transmission/redial key 32, and LCD display unit 33 as described above, the base unit 20 is also equipped with volume controlling keys, a setting key, a cancellation key, a transfer/hook key, a speaker key, a hold key, and the like. The transmission/redial key 32 is a key functioning as a combination of the conventional transmission key and redial key, and can request a call to the dialed number or can redial by performing an input operation of this key.

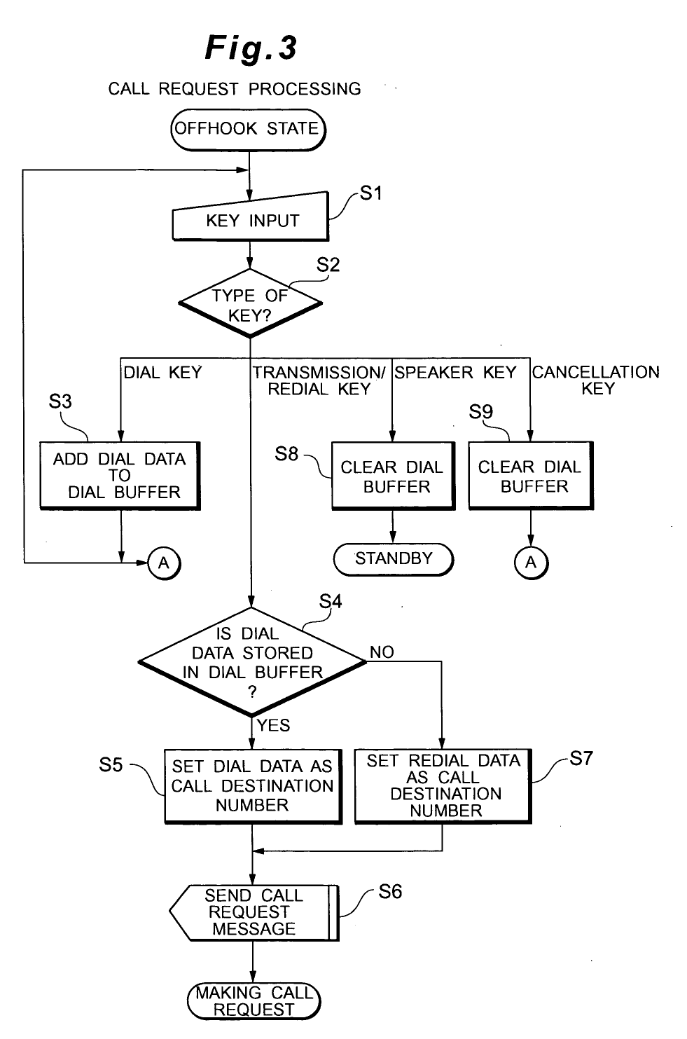

FIG. 3 is a flow chart explaining call request processing executed by the control unit 22. As shown in the figure, in an offhook state, when a key input is detected (step S1), the type of the key that was pressed is checked (step S2). If the pressed key is a dial key, the dial data is stored in the dial buffer 29 (step S3), whereby the procedure returns to the step S1. If the pressed key is the transmission/redial key 32, it is checked whether there is dial data stored in the dial buffer 29 (step S4).

If there is dial data stored in the dial buffer 29 (step S4; YES), the dial data is set as a call destination number (step S5), and a call request message is sent (step S6). On the other hand, if dial data is not stored in the dial buffer 29 (step S4; NO), redial data is set as the call destination number (step S7), and a call request message is sent (step S6). Preferably, the redial data is of the terminal number in the outgoing to which a call was made most recently, but it is not limited to this. For example, it may be constituted such that a caller can select a terminal number from among the list in the outgoing history or incoming history.

If the pressed key is the speaker key, the dial buffer 29 is cleared (step S8), and the procedure moves on to a standby mode. If the pressed key is the cancellation key, the dial buffer 29 is cleared (step S9), and the procedure returns to the step S1.

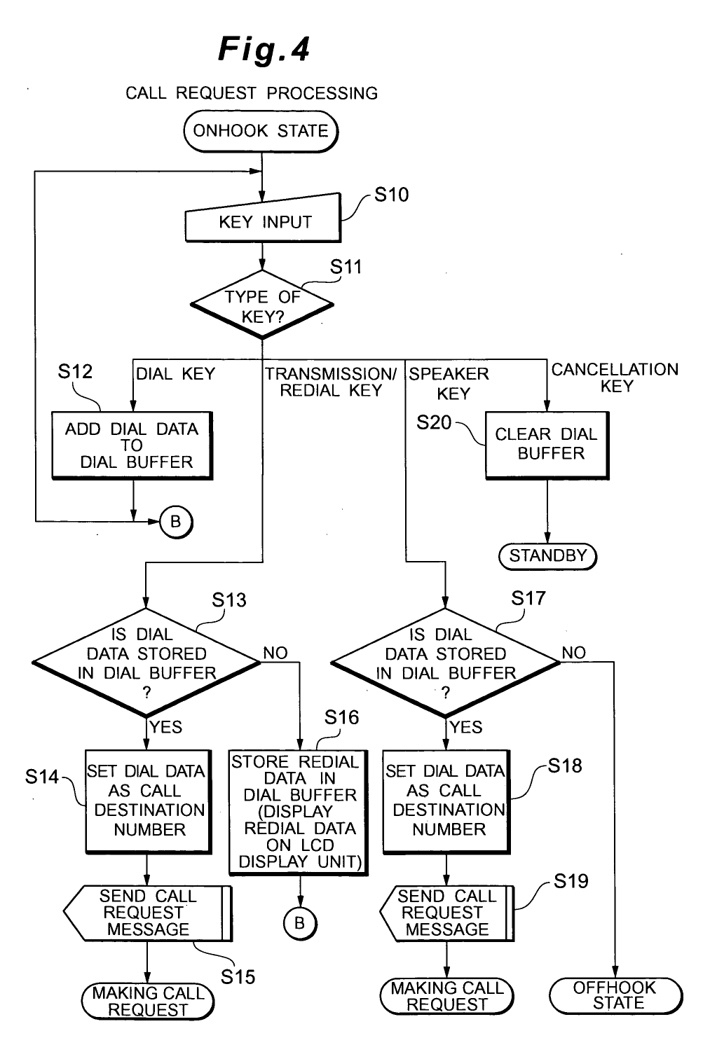

FIG. 4 is a flow chart explaining call request processing executed by the control unit 22. As shown in the figure, in an onhook state, when a key input is detected (step S10), the type of the key that was pressed is checked (step S11). If the pressed key is a dial key, the dial data is stored in the dial buffer 29 (step S12), and the procedure returns to the step S10. If the pressed key is the transmission/redial key 32, it is checked whether there is dial data stored in the dial buffer 29 (step S13).

If there is dial data stored in the dial buffer 29 (step S13; YES), the dial data is set as a call destination number (step S14), and a call request message is sent (step S15). On the other hand, if dial data is not stored in the dial buffer 29 (step S13; NO), the redial data is set in the dial buffer 29 and further displayed on the LCD display unit 33 (step S16). The procedure then returns to the step S10. With such configuration, when pressing the transmission/redial key 32 twice in the onhook state, by the first input operation, the redial data is displayed on the LCD display unit 33 and is stored in the dial buffer 29, and, by the second input operation, the redial data stored in the dial buffer 29 can be used as a call destination number to request a call. Preferably, the redial data is of the terminal number in the outgoing history to which a call was made most recently, but it is not limited to this. For example, it may be constituted such that a caller can select a terminal number from among the list in the outgoing history or incoming history.

If the pressed key is the speaker key, it is checked whether there is dial data stored in the dial buffer 29 (step S17), and if dial data is stored (step S17; YES), the dial data is set as a call destination number (step S18), and a call request message is sent (step S19). On the other hand, if dial data is not stored (step S17; NO), the procedure moves on to an offhook state. If the pressed key is the cancellation key, the dial buffer 29 is cleared (step S20), and the procedure moves on to a standby mode.

According to the present embodiment, the transmission/redial key 32 is enabled to function as a combination of conventional transmission and redial keys, and hence the IP telephone set 10 is also enabled to have an increased number of functions. Furthermore, redial transmission is possible only by operating the transmission/redial key 32 once (in the offhook state) or twice (in the onhook state) even if data is not stored in the dial buffer 29. This provides a high level of convenience.

The present invention has been explained, taking the IP telephone set 10 as an illustrative example hereinabove, however, the call request control device of the present invention can be applied to a digital telephone set such as an ISID telephone set that sends dial data in batch mode. Other variations, modifications and alternative embodiments of the invention will readily suggest themselves to those of ordinary skill in the art based on the disclosure herein, and therefore are to be regarded as being within the spirit and scope of the invention.

1. A call request control device, comprising:
a dial buffer for storing dial data;
a control unit for controlling a call request; and
a transmission/redial key for requesting said control unit for call request processing,
wherein, in cases where said transmission/redial key is input, if dial data is stored in said dial buffer, said control unit performs call request processing by using said dial data as a call destination number, whereas, if dial data is not stored in said dial buffer, said control unit performs call request processing by using redial data as the call destination number.

2. A call request control device, comprising:
a dial buffer for storing dial data;
detection means for detecting onhook/offhook status;
a control unit for controlling a call request; and
a transmission/redial key for requesting said control unit for call request processing,
wherein, in cases where said transmission/redial key is input in an offhook state, if dial data is stored in said dial buffer, said control unit performs call request processing by using said dial data as a call destination number, whereas, if dial data is not stored in said dial buffer, said control unit performs call request processing by using redial data as the call destination number.

3. A call request control device, comprising:
a dial buffer for storing dial data;
a display unit for displaying a call destination number;
detection means for detecting onhook/offhook status;
a control unit for controlling a call request; and
a transmission/redial key for requesting said control unit for call request processing,
wherein, in cases where said transmission/redial key is input in an onhook state, if dial data is stored in said dial buffer, said control unit performs call request processing by using said dial data as a call destination number, whereas, if dial data is not stored in said dial buffer, said control unit displays redial data as the call destination number on said display unit, and performs call request processing by using said redial data as the call destination number when said transmission/redial key is re-input.

4. An IP telephone set, which comprises the call request control device according to claim 1.

5. An IP telephone set, which comprises the call request control device according to claim 2.

6. An IP telephone set, which comprises the call request control device according to claim 3.
